(19) United States
(12) Patent Application Publication
(10) Pub. No.: US 2004/0244805 A1
(43) Pub. Date: Dec. 9, 2004

(54) Mouthguard storage case

(76) Inventors: William A. Cook, Lakeville, MN (US); Mark Herman, Minneapolis, MN (US)

Correspondence Address: BRIGGS AND MORGAN, P.A., 2200 IDS CENTER, MINNEAPOLIS, MN, 55402, US

(21) Appl. No.: 10/646,598

(22) Filed: Aug. 21, 2003

Related U.S. Application Data
(60) Provisional application No. 60/475,572, filed on Jun. 3, 2003.

(51) Int. Cl. A61C 5/14

(52) U.S. Cl. 128/859; 128/861

(57) ABSTRACT

A protective case for a mouthguard has a base, a cover hinged to the base, and a partition on the base adapted to engage the mouthguard and to prevent movement of the mouthguard within the case. Alternatively, the protective case has a pivoting mouthguard holder that is spring-biased so as to raise the mouthguard away from the base when the cove is opened.

This application is a continuation-in-part of provisional application serial number ______, filed Jun. 13, 2003, entitled MOUTHGUARD CASE.

### BACKGROUND OF THE INVENTION

The present invention relates generally to protective mouthguards for use in athletics and more particularly, to a protective case for a mouthguard. Mouthguards generally are characterized as being nonpersonalized, universal and stock model type, or are customized to have direct upper jaw tooth-formed contact. Additionally, the mouthguards may be tethered or untethered. Mouthguards that are to be tethered may be fastened to a helmet or face guard to prevent the chance of the mouthguard from being lost as well as to prevent swallowing of the mouthguard or choking on the mouthguard by the user. Custom mouthguards that are personalized for the individual wearer or user may be created by technicians, practitioners or dentists. Alternatively, users, as well as dentists, may create custom fit mouthguards to have direct contact with the teeth, gums and jaws by way of the boil-and-bite method. Ethylene vinyl acetate (EVA) material works suitably well as a thermoplastic material for mouthguards. The EVA mouthguard will readily soften when submerged in boiling water momentarily afterwhich the mouthguard may be removed and fitted about the user's upper jaw, teeth and gums afterwhich the user applies contact pressure as well as suction to custom fit the mouthguard to the upper jaw.

The most common problem with EVA-like material mouthguards that are to be heated and then fitted to the user is that the heated mouthguards become limp and completely lose their shape upon heating. A heated, limp mouthguard is difficult to fit within the user's mouth and quickly form about the user's upper jaw in a timely fashion before the EVA-like material becomes stiff or hard. This problem becomes even more heightened when the particular mouthguard design is further customized to have additional features, such as occlusal pads, or an anterior impact brace which must be properly aligned and positioned.

Further still, dentists, team doctors, practitioners and equipment personnel have had an increasing concern for the temporo mandibular joint (TMJ) and protecting the TMJ from injury. Consequently, the alignment and positioning of the lower jaw and indexing of the lower jaw upon the softened mouthguard to be formed have all recently been receiving additional attention and consideration.

U.S. Pat. Nos. 5,203,351 and 5,323,787 disclose storage containers for mouthguards.

U.S. Pat. No. 6,553,996 discloses a mouthguard with an antimicrobial additive and is herein incorporated by reference.

In one aspect of the present invention, which will be discussed below, a mouthguard case provides an advantage over these patents in that the mouthguard case has internal partitions which hold the mouthguard firmly in place.

In another aspect of the present invention, a mouthguard case provides an advantage over these patents in that the mouthguard case has a spring-biased, pivoting, internal mouthguard holder that raises to present the mouthguard to the wearer when the case is opened. This eliminates the need for the wearer to try to grip the mouthguard while it is lying flat in the case.

In another aspect of the present invention, a mouthguard case provides an advantage over these patents in that the mouthguard case can be impregnated with an antimicrobial agent to prevent the growth of bacteria and other microbes while the mouthguard is in the case.

In another aspect of the present invention, a mouthguard case provides an advantage over these patents in that the mouthguard case has a tether that can be used to connect the case to an athletic helmet.

### SUMMARY OF THE INVENTION

A protective case for a mouthguard has a base, a cover hinged to the base, and a partition on the base adapted to engage the mouthguard and to prevent movement of the mouthguard within the case. Alternatively, the protective case has a pivoting mouthguard holder that is spring-biased so as to raise the mouthguard away from the base when the cove is opened.

A principle object and advantage of the present invention is that the mouthguard case has an internal partition which holds the mouthguard firmly in place.

Another principle object and advantage of the present invention is that the mouthguard case has a spring-biased, pivoting, internal mouthguard holder that raises to present the mouthguard to the wearer when the case is opened. This eliminates the need for the wearer to try to grip the mouthguard while it is lying flat in the case.

Another principle object and advantage of the present invention is that the mouthguard case can be impregnated with an antimicrobial agent to prevent the growth of bacteria and other microbes while the mouthguard is in the case.

Another principle object and advantage of the present invention is that the mouthguard case has a tether that can be used to connect the case to an athletic helmet.

### BRIEF DESCRIPTION OF THE DRAWINGS

FIG. 1 is a perspective view of the mouthguard case of the present invention.

FIG. 2 is a perspective view of the mouthguard case of the present invention, showing insertion of a mouthguard into the case.

FIG. 3 is a perspective view similar to FIG. 2, showing another embodiment of the mouthguard case of the present invention.

FIG. 4 is a side elevational view of the mouthguard case of FIG. 3, with some structure cut away to show internal structure.

FIG. 5 is similar to FIG. 4, with the cover closed.

FIG. 6 is a detailed view of the springs of the mouthguard of FIG. 4.

FIG. 7 is a cross-section taken at approximately the lines 7 of FIG. 1.

FIG. 8 shows attachment of the mouthguard of the present invention to an athletic helmet by means of a tether.

FIG. 9 is a detailed view of the mouthguard holder and spring of the embodiment of FIG. 6.

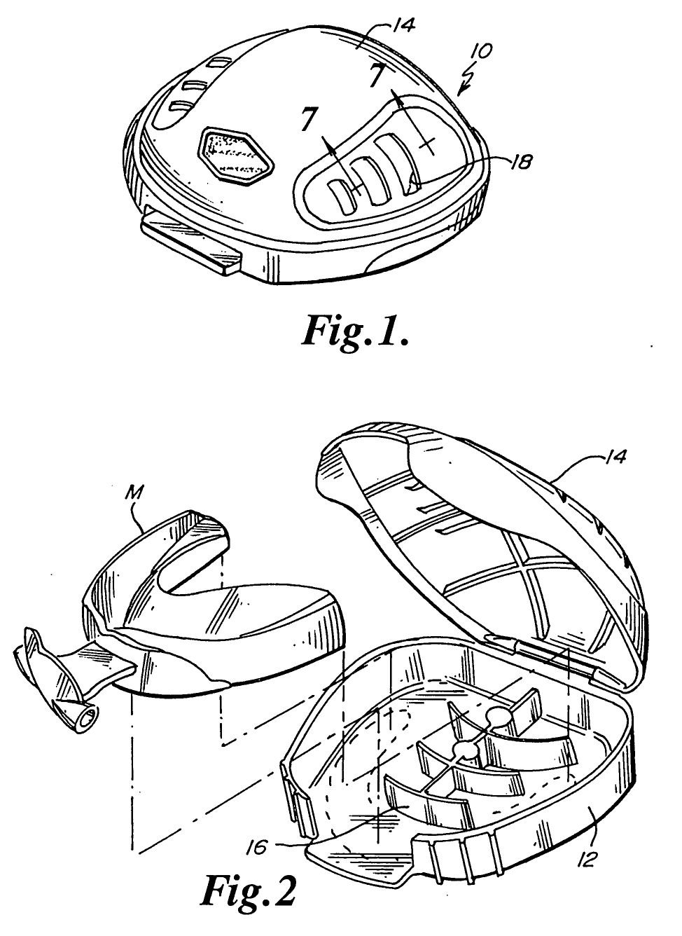

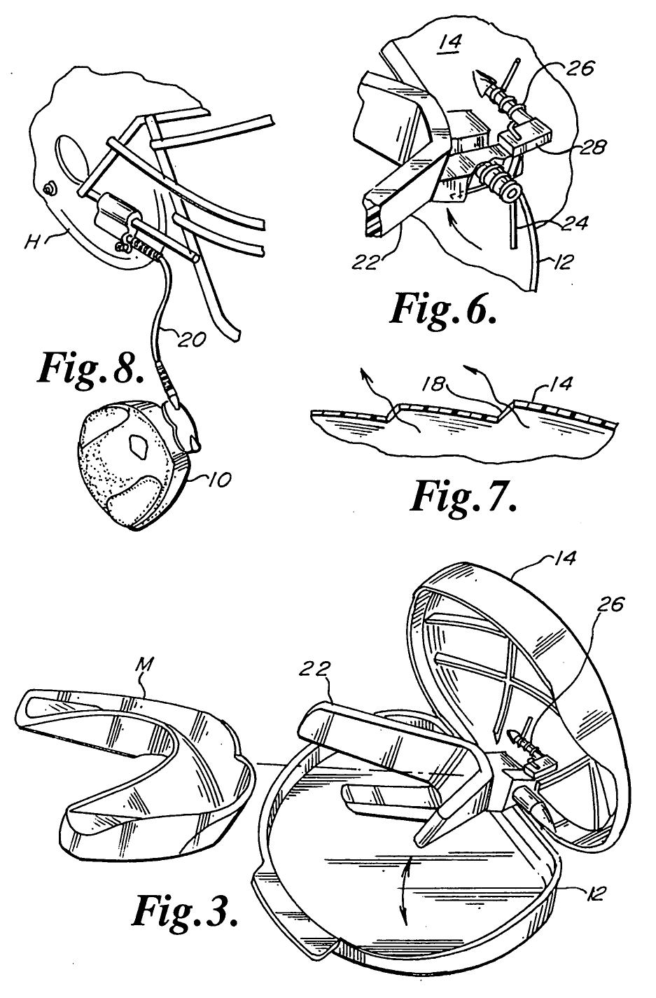

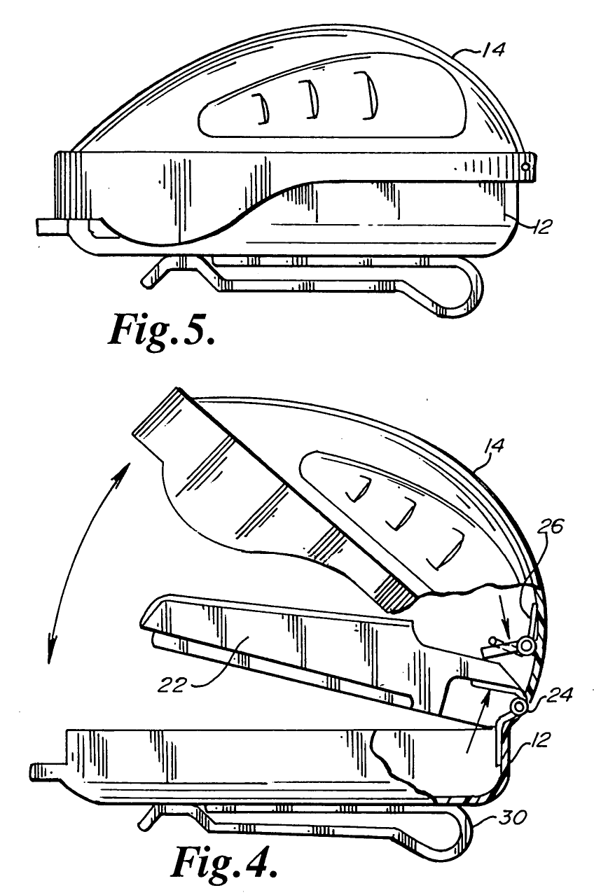

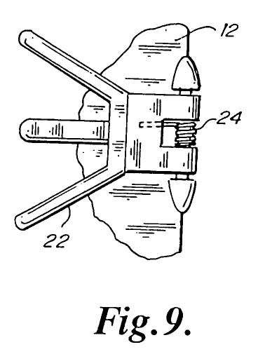

### DETAILED DESCRIPTION OF THE PREFERRED EMBODIMENT

The mouthguard case of the present invention is generally shown in the Figures as reference numeral 10.

In one embodiment, the mouthguard case 10 further comprises a base 12, a cover 14 hinged to the base 12, and a partition 16 adapted to engage the mouthguard M and to prevent movement of the mouthguard M within the case 10. Preferably, the partition 16 is oriented substantially normal to the base 12.

In one embodiment, the partition 16 is curved to match the shape of the mouthguard M.

In one embodiment, the mouthguard case 10 has vent apertures 18 which allow air to circulate into and out of the case 10, thereby assisting in drying the mouthguard and in preventing growth of microbes.

In one embodiment, the mouthguard case 10 is impregnated with an antimicrobial agent. A method of incorporating an antimicrobial agent into a polymer is disclosed in U.S. Pat. No. 6,553,996, herein incorporated by reference.

In one embodiment, the mouthguard case 10 further comprises a tether 20 adapted to secure the case 10 to an athletic helmet H.

In one embodiment, the mouthguard case 10 further comprises a mouthguard holder 22 pivotally engaging the base 12. Preferably, a first spring 24 biases the mouthguard holder 22 away from the base 12.

In one embodiment, the mouthguard case 10 further comprises a second spring 26 biasing the cover 14 away from the base 12.

In one embodiment, the mouthguard case 10 further comprises a stop 28 on the cover 14, the stop 28 engaging the second spring 26 and slidingly engaging the mouthguard holder 22, whereby motion of the cover 14 away from the base 12 allows the first spring 24 to raise the mouthguard holder 22 and mouthguard 10, and whereby motion of the cover 14 toward the base 12 forces the mouthguard holder 22 and mouthguard 10 toward the base 12.

In one embodiment, the mouthguard case 10 further comprises a belt clip 30 adapted to removably attach the case 10 to the user's belt (not shown).

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A protective case for a mouthguard, comprising:
(a) a base;
(b) a cover hinged to the base; and
(c) a partition oriented substantially normal to the base, the partition being adapted to engage the mouthguard and to prevent movement of the mouthguard within the case.

2. The protective case of claim 1, wherein the partition is curved to match the shape of the mouthguard.

3. The protective case of claim 1, wherein the case is impregnated with an antimicrobial agent.

4. The protective case of claim 1, further comprising a tether adapted to secure the case to an athletic helmet.

5. A protective case for a mouthguard, comprising:
(a) a base;
(b) a cover hinged to the base;
(c) a mouthguard holder pivotally engaging the base; and
(d) a first spring biasing the mouthguard holder away from the base.

6. The protective case of claim 5, further comprising a second spring biasing the cover away from the mouthguard holder.

7. The protective case of claim 6, further comprising a stop on the cover, the stop engaging the second spring and slidingly engaging the mouthguard holder, whereby motion of the cover away from the base allows the first spring to raise the mouthguard holder, and whereby motion of the cover toward the base forces the mouthguard holder toward the base.

8. The protective case of claim 5, wherein the case is impregnated with an antimicrobial agent.

9. The protective case of claim 5, further comprising a tether adapted to secure the case to an athletic helmet.

10. The protective case of claim 5, further comprising a belt clip.

11. The protective case of claim 5, further comprising a vent aperture.
